(19) United States
(12) Patent Application Publication
(10) Pub. No.: US 2023/0359583 A1
(43) Pub. Date: Nov. 9, 2023

(54) CONTINUOUS DATA PROCESSING WITH MODULARITY

(71) Applicant: Airbiquity Inc., Seattle, WA (US)

(72) Inventors: Jack William Bell, Darrington, WA (US); Darrin Garrett, Kingston, WA (US); Matthew Cedric Vogel, Lansing, KS (US); Dana Richard Powell, Manotick (CA)

(21) Appl. No.: 17/737,709

(22) Filed: May 5, 2022

(51) Int. Cl. G06F 15/82; G06F 16/2455

(52) U.S. Cl. CPC G06F 15/82; G06F 16/24568

(57) ABSTRACT

In various embodiments, and apparatus may include at least one hardware processor; and a pipeline data processor implemented on the at least one hardware processor, the pipeline data processor including at least one source module to provide at least one continuous data stream to one or more processing pipelines and at least one sink module to input data from the one or more processing pipelines; wherein the pipeline data processor comprises a plurality of different paths extending through the plurality of pipeline analytic modules; wherein the input paths are forward-only requiring that an input of one pipeline analytic module of a processing pipeline is output by another pipeline analytic module earlier in the processing pipeline or the at least one source module. Other embodiments may be disclosed and/or claimed.

### COPYRIGHT NOTICE

© 2022 Airbiquity Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

Embodiments of the present disclosure relate to the field of continuous data processing, and in particular, to methods and apparatuses associated with continuous data processing using modular pipelines.

### BACKGROUND

Continuous data processing includes capturing data when it becomes available, filtering or modifying it, and then forwarding it on for further processing; all done one piece of data at a time. This is different from aggregate data processing, such as done with databases or files, where the full data set is known before processing starts and where the data might be processed with multiple passes. In other words, while continuous data processing might be able to retain some values or portions of previous pieces of data while processing a current piece of data, it cannot also refer to pieces of data that have not yet become available. Moreover, this processing is continuous, meaning there may be no effective ‘end’ to the data processing and the processing may continue for as long as data is available. Finally, the timing and amount of data to process may not be predictable and the processing may occur either occasionally or often, processing one piece or many pieces of data at a time. These facts mean many existing tools and methods of processing large amounts of data cannot be applied to continuous data processing.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

Some known methods of continuous data processing on devices with one or more digital processors may result in non-reusable and non-modular code with limited interconnectivity between devices. Various embodiments of continuous data processing with modularity may include processors, pipelines, and modules to provide a conceptual and runtime framework that enables modular and re-usable software development and cross-platform and highly interconnected implementations. Various embodiments may provide a simple conceptual framework for understanding and implementing highly complex data analytic systems with:
Extreme emphasis on modularity, with functionality broken down into:
   Source Modules that acquire data from outside the processing unit, e.g., access data from external software source(s), read data from files, capture data from hardware sensors, or generate data based on internal state, or the like, or combinations thereof;
   Pipeline Analytic Modules arranged into pipelines to process data in stages; and
   Sink Modules to send data out of the processing unit for further processing; Mapping rules applied to:
Sources to Pipelines;
   Pipeline Analytic Modules from Pipeline input or any previous Module in the Pipeline;
   Pipeline Analytic Modules to Pipeline output (which may be performed selectively—in which a pipeline analytic module may act as a filter);
   Pipelines to Sinks;
   The mapping module of a Pipeline Data Processor:
      1 to N ‘Source Modules’ which get one or more data types using whatever method is required and ‘pump’ that data through any Pipelines with any Module that inputs the data type;
      1 to N ‘Pipelines’ each consisting of 1 to N ‘Pipeline Analytic Modules’ that input one or more data types and output one or more data types, using mapping rules that allow bypassing subsequent or previous modules as described above; and
      1 to N ‘Sink Modules’ which are mapped to one or more data types from Pipeline outputs and forward the data using whatever method is required;
Data Type Mapping may be module-specific if two different modules may produce the same data type, but data from only one of the modules is required for a given application (e.g., video data may be available from a front facing camera or a rear view camera, but an application may require only video data from the front facing application).
Multiple Pipelines sharing the same Sources and Sinks; and/or
Designed to take advantage of multi-processor/multi-core applications, but capable of running on systems with limited resources.

Additional aspects and advantages of this invention will be apparent from the following detailed description of preferred embodiments, which proceeds with reference to the accompanying drawings.

### BRIEF DESCRIPTION OF THE DRAWINGS

FIG. 1 schematically illustrates a system including a pipeline data processor host to provide continuous data processing, according to various embodiments.

FIG. 2 schematically illustrates a system to provide continuous data processing using devices interconnected by a client internal network, according to various embodiments.

FIG. 3 schematically illustrates a package deployable on one or more devices to provide continuous data processing on the device(s), according to various embodiments.

FIG. 4 schematically illustrates a package deployable on a single device to provide continuous data processing on the single device, according to various embodiments.

FIG. 5 schematically illustrates a package deployable on interconnected devices to provide continuous data processing on the interconnected devices, according to various embodiments.

FIG. 6 schematically illustrates a forward-only pipeline to provide continuous data processing, according to various embodiments.

FIG. 7 schematically illustrates a single pipeline data processor to provide continuous data processing, according to various embodiments.

FIG. 8 schematically illustrates a multiple pipeline data processors to provide continuous data processing, according to various embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Continuous data processing may be performed as close to the source—the place where that data first becomes available for digital processing—as possible. There are a variety of advantages for this, including the likelihood this digital processor many have limited external connectivity incapable of handling the raw data if sent at high rates. However, in many cases the digital processor at this source also has limited computing resources and must perform such processing without also stalling the capture of data, resulting in data loss, or interfering with other processing. Therefore, it is preferable to perform continuous data processing using minimal computing resources, and without affecting whatever else the digital processing device is doing.

Software for this kind of continuous processing has been created as one-off implementations that may be specific to the digital processor and its environment, and are monolithic rather than modular. At best, code reusability is achieved using libraries for heavy mathematical processing or system resources; but the structure of such applications are single-pathed along the lines of (1) Read data, (2) Process data, possibly using library functions, (3) if (2) results in output, send data, and (4) Go to (1).

Achieving a higher level of modularity requires a supporting framework of some kind and a scheme for creating and managing the data types, the processing modules, the inputs and outputs, and so on. For the specific purpose of continuous data processing there are few such framework implementations extant, none of which meets all this criteria. In the specific case of performing continuous data processing on digital processors with limited resources there are even fewer.

Various embodiments described herein met one or more of the following features:
Highly modular and implemented in a way that encourages ‘composable’ systems assembled from simple pre-written modules;
Highly Portable: can run the same modules on anything from limited process control devices with minimal CPU and RAM to highly capable systems with powerful operating systems and no resource limitations;
Allow non-portable implementations when required for a use case;
May be implemented to not interfere with other processing, where required;
Provides the highest data throughput with the least possible resource usage;
Capable of processing many kinds of data at once; and/or
Capable of taking advantage of interconnected systems containing multiple digital processors while remaining effective on systems with a single digital processor.

One extant large volume data processing model, called ‘MapReduce’ (https://en.wikipedia.org/wiki/MapReduce), may be applied to continuous data processing. MapReduce processes large amounts of data by ‘mapping’ a large data set to a single function that ‘reduces’ that data into an output. Note that MapReduce has a similar limitation as continuous data processing—the reduce function cannot access later data while processing current data.

MapReduce works by first limiting the entire data set to a smaller data set you want to reduce, this is the ‘map procedure’ which filters and sorts the data. The data is then sent to the ‘reduce function’ which summarizes the data or otherwise uses it to create the output data. MapReduce is very effective at processing very large amounts of data by breaking up the mapped data and distributing the ‘reducing operation’ across a number of computers and process that data in parallel. It also encourages the creation of very simple reduce functions, as opposed to creating large and complex implementations.

However, applying MapReduce on its own to continuous data processing does not provide modularity by itself; rather it is simply another way of creating monolithic applications not much different than the existing common practice. There is also the problem of a single reduce function either being too simplistic or overly complex for many use cases. And, in fact, most ‘Big Data’ MapReduce implementations performing anything but the simplest calculations are usually done using multiple passes; where the output data from one pass is then MapReduced again in another pass using a different map procedure and reduce function.

Another extant model of data processing is the ‘data pipeline’ (https://en.wikipedia.org/wiki/Pipeline (computing)). A data pipeline may include multiple modules, where the data is read into one module and that module's output is read into the next module and so on.

Combining these models together may result in the following data processing model:
1. Read Data, with the ability to filter (map) based on some rules
2. Process data stepwise (reduce) through a pipeline consisting of 1 to N modules:
   a. Send data to module 1
   b. If module 1 produces output, send data to module 2
   c. If module 2 produces output, send data to module 3
   d. . . .
   e. If module N produces output, send data out of pipeline
3. If pipeline results in output, send data
4. Go to (1)

However, this simple pipeline model is limited by (a) being entirely linear and (b) not providing enough ‘mapping’. Hewing too closely to this model results in highly specialized and tightly coupled (meaning, ‘less re-usable’) modules and the easiest way to apply it is to create a single module that does everything, i.e. the monolithic approach. There are other issues as well, including the fact one digital processor might have many data types available to process, something not suited to a single pipeline, and creating a single way to do the filtering/mapping step might limit the use cases to which it can be applied.

Some embodiments described herein may apply the concept of data mapping to multiple places throughout the pipeline model, instead of only at the input site.

First, modules in a pipeline are not required to process the output from the module directly before them. Instead, the pipeline may map incoming data from the source to any module in the pipeline, not just the first module, and may map output from any module to the input of any other module further down the pipeline. Also, output from any module may be mapped out of the pipeline to a sink as well as to a subsequent module. This enables the creation of modules with more generalized implementations, entirely decoupled from other modules aside from the data types they input and output. And, in this model, pipelines represent a single arbitrarily complex unit of data analysis composed out of simple modules.

Second, the data mapping to, within and out of a pipeline is not limited by data type: the pipeline inputs may be any data type available, as may the internal pipeline processing and outputs—so long as the module inputting the data is implemented to do so.

Third, incoming data may be mapped to more than one pipeline at a time, where each pipeline is doing a different kind of processing—possibly with different data types from different capabilities of the digital processor—and outgoing data may be mapped to multiple outputs for further processing. In other words, multiple process inputs may be mapped to multiple pipelines and the pipeline outputs may be mapped to multiple process outputs—all at the same time and without interfering with each other.

Various embodiments described herein may include a “Pipeline Data Processor,” which may contain:
1 to N ‘Source Modules’ which get one or more data types using whatever method is required and ‘pump’ that data through any pipelines with any module that inputs the data type;
1 to N ‘Pipelines’ each including 1 to N ‘Pipeline Analytic Modules’ that input one or more data types and output one or more data types, using mapping rules that allow bypassing subsequent or previous modules as described above; and
1 to N ‘Sink Modules’ which are mapped to one or more data types from pipeline outputs and forward the data using whatever method is desired.

This pipeline data processor may provide a basic framework for performing continuous data processing via arbitrary modules, where the modules implement a simple interface but may perform their function in any way appropriate to the data and the digital processor they are running on. Thus, a source module may get raw data from a CAN (controller area network) bus, a file or queue, a network connection, or any other capability of the digital processor. In the same way a sink module may send the processed data out in any number of ways and pipeline analytic modules may use any capability of the digital processor as needed to perform their function.

Some embodiments described herein may feature easy creation of pipelines and pipeline data processors composed from a number of small and adaptable modules. Various embodiments described herein may provide a conceptual framework for understanding how modules operate and are composed into data processing systems; provide a runtime framework to host pipeline data processors composed from modules to implement these data processing systems; and provide a cross-platform library for selected system functionality module developers may use to create cross-platform implementations.

Various embodiments may host a pipeline data processor in a sandbox and provide it with a cross-platform library for accessing basic digital processor capabilities. Resource usage may be limited via the sandbox and/or cross-platform modules via the library. Various embodiments may provide limiting factors and encourage module re-usability while also providing a way to do things outside of those limitations if required by the use case. A module developer can implement to the framework and the cross-platform library and the same code will run in various hardware and/or software environments.

Some embodiments may implement the pipeline data processor and/or the sandbox in ways appropriate to the digital processor and its capabilities, which means multi-threading and process control may be utilized, if provided (or implement without those capabilities, if not). Resource requirements may be reduced on low resource systems and/or data processing may be throttled, if required.

Since the individual modules may be simple implementations and the mapping rules may be very simple to implement, the resource usage of a pipeline data processor consisting of pipelines and modules may be comparable to the same use case implemented as a difficult-to-maintain monolithic system.

Finally, on large interconnected systems with multiple digital processors the source module may provide the raw data (and may also perform minimal processing to reduce network usage on some devices), then send that partially processed data to one or more other devices in the system for further processing; spreading the processing load out like some ‘MapReduce’ implementations, but using a framework designed to provide significantly more control over how and where that processing occurs (e.g., in multiple devices on the same edge client, multiple co-operating edge clients, or a mix of edge clients and cloud servers).

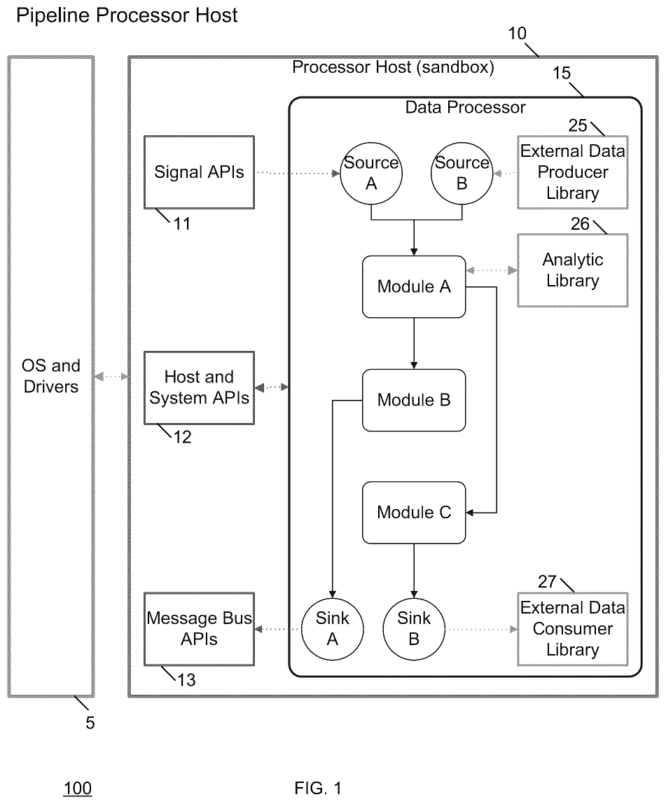

FIG. 1 schematically illustrates a system 100 including a pipeline data processor host 10 (e.g., a sandbox) to provide continuous data processing, according to various embodiments. The pipeline data processor host 10 acts as a host to one or more pipeline data processors 15 (e.g., pipeline processors), providing access to the underlying operating system and hardware drivers 5 via cross-platform APIs 12 (e.g., portable APIs (application programming interface)). The pipeline data processor host 10 may control the pipeline data processor runtime operations and limit its access to system resources, including memory and physical processor resources.

In cases where a sink (e.g., sinks A and B), a source (e.g., sources A and B), or an pipeline analytic module (e.g., modules A-C) require access to system resources not mediated by the pipeline data processor host 10, arbitrary external libraries 25-27 may be compiled in the pipeline data processor 15 to provide those capabilities.

Modules written to use only the cross-platform APIs 12 may run on various platforms (e.g., any system with enough resources for those modules). In various embodiments, the cross-platform APIs 12 may include signal APIs for capturing system data (such as CAN Bus signals), message bus APIs for sending and receiving data over the internal client network, or other host and system APIs to support the pipeline data processor(s) 15 and modules (which may include runtime logging or profiling functionality).

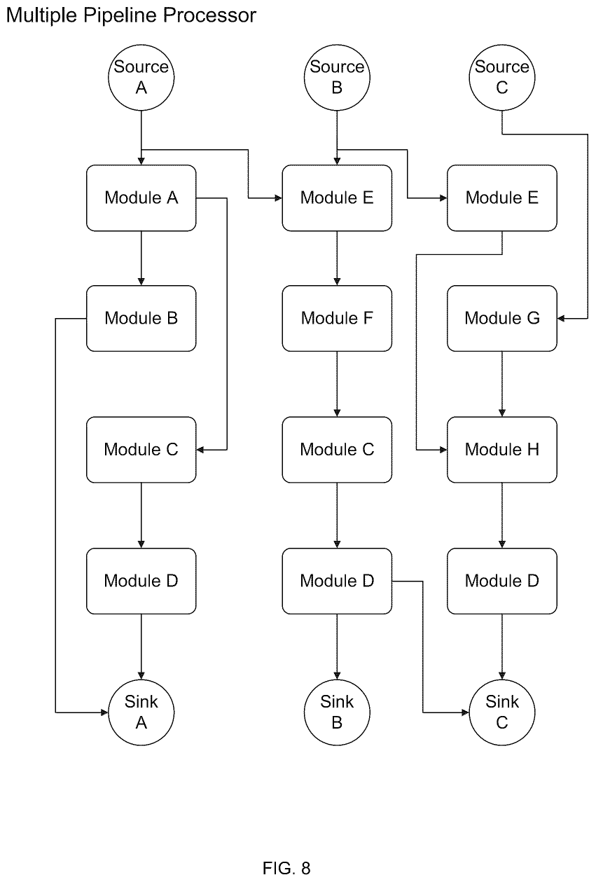

In various embodiments, a source module (e.g., source A or source B in this example) may use a map function to map incoming data of a continuous data stream to different reducers selected from different ones of the pipeline analytic modules. Referring briefly to FIG. 8, source A maps to an initial module of a first pipeline (e.g., including Modules A-D) and initial module of a second pipeline (e.g., including Modules E, F, C, and D), source B maps an initial module of the second pipeline and an initial module of a third pipeline (e.g., including Modules E, G, H, and D), and Source C maps to a different module of the third pipeline. One or more of these reducers may use a map function to map its output to different reducers/sinks selected from the pipeline analytic modules or sinks (e.g., the first pipeline's module A's output is mapped to modules A and C, the second pipeline's module E is mapped to module F, and the third pipeline's module E is mapped to Module H). Map functions can be implemented by generating code for the mappings in which the runtime code functions differently from some pure mapping implementations in that it is specific to the mapping input used to generate the code. Mapping functions are considered to be generalized data-driven implementations; however, they may be pre-optimized by converting the data directly into specific code via a code generator.

In various embodiments, map functions may be generalized implementations data-driven by a description of the mappings (e.g., pipeline description language code) or may be runtime-optimized by generating mapping-specific source code from a description of the mappings. In various embodiments, mapping may be by data type and/or which module is outputting the data, not by key like some other mapping approaches.

Referring again to FIG. 1, the system 100 may be implemented using one or more hardware processors. In various embodiments, the one or more hardware processors may part of a single device or distributed over interconnected devices that communicate with each other over external interfaces.

In various embodiments, the one or more hardware processors may include a general purpose integrated circuit (e.g., a general purpose CPU) or an application specific integrated circuit (ASIC), or combinations thereof.

In one embodiment, the system 100 may be used for vehicle edge data processing. The system 100 may pre-process data generated by vehicle sensors on the “edge,” before the data is transmitted—to the cloud over a communications networks. In such an example, a source module may provide data originating in the vehicle (e.g., vehicle sensor data, in a raw or pre-processed state), and a sink module may provide the pipeline-processed data to the cloud. The pipeline processing may transform the vehicle sensor data to reduce transmission expenses, avoid data throttling, for data privacy preservation, optimize distributed data analysis involving the cloud, or the like.

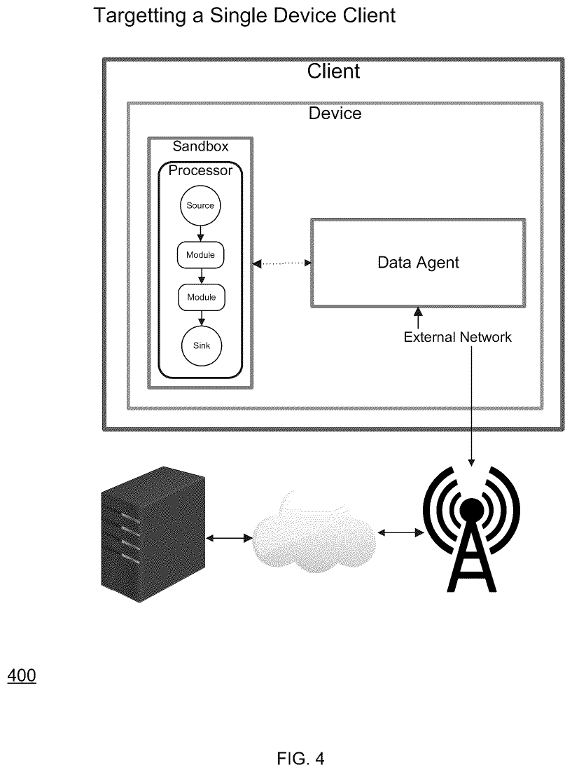

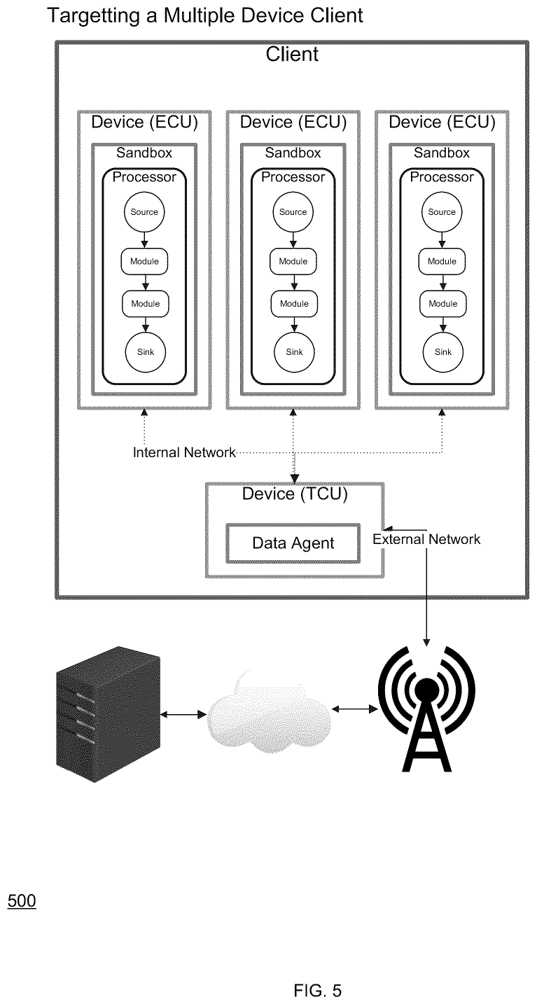

One vehicle edge data processing implementation may include one or more pipeline data processors running on one or more first devices and a data agent (similar to FIGS. 4 and 5). The data agent may run on the same device as one or more pipeline data processors or may reside on a separate device. The data agent may cache pipeline processed data (from the one or more first devices) locally until an appropriate Internet network connection is available. Availability may be determined using rules for expected opportunities or scenarios, including cache until any network is available, cache until or lower cost or higher bandwidth network is available, send high-value or low volume data over a lower bandwidth or more expensive network and cache other data until a lower cost or higher bandwidth network is available, or the like, or combinations thereof. When availability is detected, the data agent may send the cached data up to a server for further processing, after which the data agent may clear the cache.

In vehicle edge data processing cases, the pipeline data processor 15 may be implemented using embedded vehicle hardware devices, such as an ECU (electronic control unit). Embedded vehicle hardware devices may include single purpose I/O hardware, which may utilize a hardware processor that includes both general purpose CPU(s) and ASICs.

The system 100 may be used in various applications and in the field of vehicle data processing or other fields. In some embodiments, the pipeline processing may perform dynamic distributed processing on server farms, in which extremely large volumes of data are processed in multiple ways through multiple steps. In some embodiments, the pipeline processing may perform advanced media (e.g., video, audio, 3D) processing distributed across multiple cores of a CPU or multiple devices for better throughput. In some embodiments, the pipeline processing may perform message-based operating system processing.

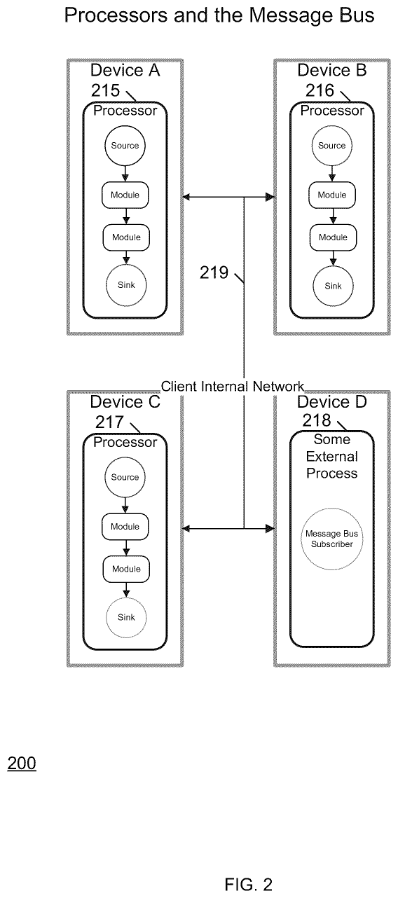

FIG. 2 schematically illustrates a system 200 to provide continuous data processing using devices A-D interconnected by a client internal network 219, according to various embodiments. To provide low cost parallel processing, the pipeline data processors 215-217 may be hosted by separate devices A-B, respectively, which may communicate with each other over the network 219 using their external interfaces. Some of the respective devices may include one to N sources modules (which obtain data from any data producer described herein), and one to N sink modules which send data elsewhere for further processing (we use the term ‘N’ here and throughout this disclosure to mean any value—of the quantity of source modules may be the same or different than the quantity of sink modules). In this embodiment, the sink on device A may publish data subscribed to by the source on device B. The sink on device B may publish data subscribed to by the source on device C. The sink on device C may publish data subscribed to by an external process on device D.

Pipeline data processors 215-217 may communicate with each other to enable distributed data processing on the client or where data from separate devices is combined for an edge computing application. Pipeline data processors 215-217 may also send data to local external processes or processes on another device D. In the illustrated example, a message bus subscriber of the device D may be associated with any upload process described herein, to cache data and uploads it to cloud server(s).

Communication over the network 219 may be performed using a message bus based on publish/subscribe semantics. The message bus may be specific to the client, its internal networks, and the contained devices. Available message bus protocols include MQTT (MQ telemetry transport) and SOME/IP (scalable service-oriented middleware/Internet Protocol) or other protocols with similar semantics. To enable message bus data interchange, there may be source and sink modules that are configured to publish or subscribe to selected data messages using the appropriate message bus protocol.

In this example, the pipeline data processors 215-217 are implemented on different hardware processors distributed over different devices (e.g., devices A-C) interconnected using external connectivity (a client internal network or some other message bus). In other examples, one or more pipeline data processors may be implemented on a hardware processor of a single device. For example, different pipeline analytic modules (e.g., reducers) of a same pipeline data processor may be implemented on the different cores (e.g., respectively). In another example, the pipeline analytic modules of one pipeline data processor may be implemented on one core and the pipeline analytic modules of another pipeline data processor may be implemented on another core.

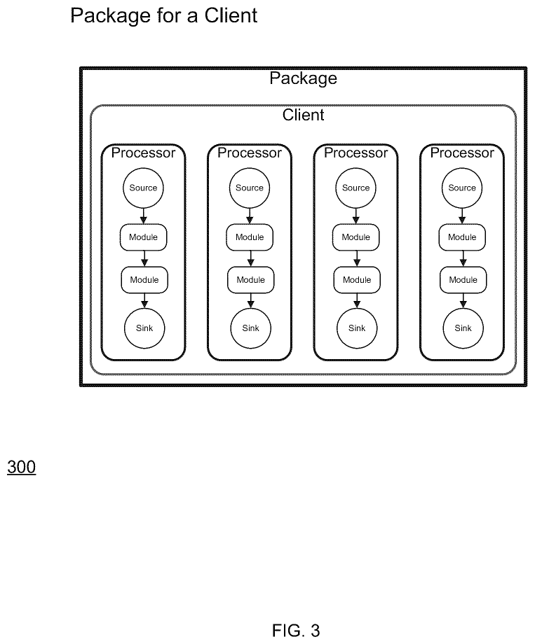

FIG. 3 schematically illustrates a package 300 deployable on one or more devices to provide continuous data processing on the device(s), according to various embodiments. The package 300 may target a specific edge data client by make and model, specifying one to N pipeline data processors, which together make up a single edge data processing application or campaign. A package specification may include everything required to build all binary assets for the pipeline data processors on the client, along with related metadata and data management configuration.

In various embodiments, the package 300 includes one or more pipeline data processors in package description language (PDL) or some other descriptive form, along with build and deployment information. The package 300 may be a PDL package consumable by a build system to output all of the binaries and other assets required for installation on a client.

Each pipeline data processor may operate independently, and in some cases may be targeted to a separate computing device on the client (e.g., devices that communicate with each other over their external interfaces). However, data may be forwarded from a message bus sink module on one pipeline data processor to a message bus source module on another pipeline data processor, allowing for distributed data processing on the client.

FIG. 4 schematically illustrates a package 400 deployable on a single device to provide continuous data processing on the single device, according to various embodiments. When a package 400 targets a single-device client, the binary assets for a single pipeline data processor host application and pipeline data processor implemented for the device may be created and installed.

A data agent application may be pre-installed or installed with the pipeline data processor host/pipeline data processor. The data agent may be responsible for caching data until a connection to the cloud is available. In various embodiments, a singular system-wide data agent may also provide message brokering capabilities, if needed by a Message Bus (MBUS) protocol. The data agent may collect output data specified in the package from sink modules in the pipeline data processor and securely transmit it to cloud server(s) for retention and further processing.

FIG. 5 schematically illustrates a package 500 deployable on interconnected devices to provide continuous data processing on the interconnected devices, according to various embodiments. When a package 500 targets a multiple-device client, the binary assets for the pipeline data processor host application and pipeline data processor for each targeted device in the package 500 are created and installed.

A data agent application may be required on a device with an Internet connection, but may be pre-installed or installed with the pipeline data processor host/pipeline data processor. The data agent may collect output data specified in the package from sink modules in the pipeline data processor and securely transmit it to cloud server(s) for retention and further processing.

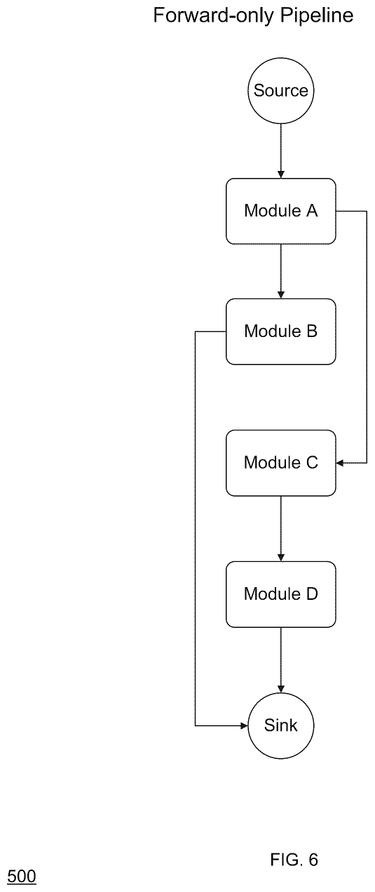

FIG. 6 schematically illustrates a forward-only pipeline 600 to provide continuous data processing, according to various embodiments. In a simple pipeline (not shown), data may be provided via a source, is processed by each module in the pipeline, and then exits the pipeline at a sink. This may result in rigid implementations where modules may only be combined in cases where the module input data is output by the previous module in the pipeline; restricting code re-use and composability or by restricting the data types modules can operate on.

In an unrestricted out-of-order group of modules (not shown), data may be provided by a source, may be processed by each module in a subgrouping following multiple paths (in contrast to a simple pipeline where there may be only a single path), and then exits the group at a sink. The multiple paths of the unrestricted out-of-order group of modules may include multiple inputs and outputs.

Although an unrestricted out-of-order group of modules may be more flexible than a simple pipeline, it may be a collection of modules connected together arbitrarily (with single entry and exit points), which may require a monolithic implementation. This may restrict code re-use and composability or restrict the data types modules can operate on. Also, such a group of modules is an open-ended network graph (rather than a pipeline). In an open-ended network graph, modules act as nodes (e.g., vertices) and data paths are the connections (e.g., edges) in between them, which may result in extreme and arbitrary complexity and require the monolithic implementation.

In a forward-only pipeline, data comes in via a source module, and may be processed by each pipeline analytic module in the pipeline following multiple paths. These multiple paths are constrained to later modules in the pipeline or to the sink module (e.g., no backward chaining), and then may exit the pipeline at a sink.

This style of pipeline provides more flexibility than the simple pipeline, while avoiding the complexity of an unrestricted out-of-order group of modules. Modules may be composed in any way appropriate to their expected data inputs and outputs, but the inputs are required to be output by another module earlier in the pipeline and the outputs must be consumed by another module later in the pipeline.

In various embodiments, pipeline data flows may be controlled by the pipeline data processor, which may initiate the flow for each source by calling a heartbeat function. In this example, the source may use signal APIs to fetch signal data and then pass the data to the pipeline analytic module A, which passes the data, in turn, to pipeline analytic modules B and C.

Pipeline analytic module B may pass its output directly to the sink module, which may use message bus APIs to send the data out as a message. Pipeline analytic module C may send its output to pipeline analytic module D, which then may send its output to the sink to be sent as a message.

This entire processing cascade may occur from the heartbeat function of the source and within a single thread of execution. The pipeline data processor may drive data through all pipelines in a single thread, which may reduce implementation complexity. The modules of the pipeline data processor may themselves independently run separate threads and perform their own thread synchronization (to execute in the same thread as the pipeline data processor).

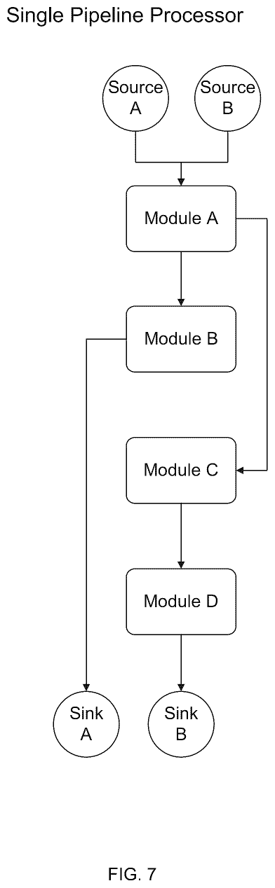

FIG. 7 schematically illustrates a single pipeline data processor 700 to provide continuous data processing, according to various embodiments. In the single pipeline data processor (e.g., single-pipeline processor), data may be provided by one to N sources, is processed by one forward-only pipeline (having multiple paths), and then exits at one to N sinks.

FIG. 8 schematically illustrates a multiple pipeline data processor 800 to provide continuous data processing, according to various embodiments. In a multiple pipeline data processor (e.g., a multi-pipeline processor), data may be provided by one to N sources, is processed by more than one forward-only pipeline (each of which having multiple paths), and then exits at one to N sink modules.

The multiple pipeline data processor combines the constrained flexibility of forward-only pipelines with the ability to share data sources and sinks between them. Although it is possible to create highly complicated processors, the conceptual complexity is advantageously limited because each pipeline may operate as a separate unit of processing.

Multiple pipeline data processors of various embodiments described herein may correspond with a PDL model for pipelines, in which:
Pipeline analytic modules are the computation entities that exist within pipelines;
The pipeline analytic modules are opaque in that the pipeline is the smallest entity abstraction of compute;
Data enters pipelines through pipeline inputs and exits through pipeline outputs;
Pipelines may be discrete entity that can be added or removed from a processor without affecting operation of any other pipeline; and
The ingress to egress data flows may adhere to the following rules: 1) a pipeline may be represented by a directed graph whereby the pipeline inputs, analytic modules, and pipeline outputs represent the nodes, and the egress to ingress data element flows between represent the edges; and 2) the pipeline is valid if and only if the graph has no cycles, all analytic modules and pipeline outputs have at least one edge, and all terminal nodes are pipeline outputs.

The data processing modules described herein may be combinable to make up a single unit of computing (e.g., a single unit of edge computing). Each data processing module may include standalone code, embeddable in software, for an individual purpose. The standalone code may take in data, put out data, and may have an API, which standalone code of the other data processing modules (for other individual purposes) can reference to consume or pass data thereto.

Most of the equipment discussed above comprises hardware and associated software. For example, the typical continuous data processing system is likely to include one or more hardware processors and software executable on those hardware processors to carry out the operations described. We use the term software herein in its commonly understood sense to refer to programs or routines (subroutines, objects, plug-ins, etc.), as well as data, usable by a machine or hardware processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

Having described and illustrated the principles of the invention in a preferred embodiment thereof, it should be apparent that the invention may be modified in arrangement and detail without departing from such principles. We claim all modifications and variations coming within the spirit and scope of the following claims.

1. An apparatus, comprising:
at least one hardware processor; and
a pipeline data processor implemented on the at least one hardware processor, the pipeline data processor including at least one source module to provide at least one continuous data stream to one or more processing pipelines and at least one sink module to input data from the one or more processing pipelines;
wherein the pipeline data processor comprises a plurality of different paths extending through the plurality of pipeline analytic modules;
wherein the input paths are forward-only requiring that an input of one pipeline analytic module of a processing pipeline is output by another pipeline analytic module earlier in the processing pipeline or the at least one source module.

2. The apparatus of claim 1, wherein the one or more processing pipelines comprises a plurality of processing pipelines, wherein at least one source comprises one or more first sources to output data to a first processing pipeline of the plural processing pipelines and one or more second sources to output data to a second processing pipeline of the plural processing pipelines.

3. The apparatus of claim 1, wherein the one or more first sources further output data to the second processing pipeline.

4. The apparatus of claim 3, wherein the one or more first sources and the one or more second sources output data to a same pipeline analytic module of the second processing pipeline.

5. The apparatus of claim 3, wherein the one or more first sources and the one or more second sources output data to different pipeline analytic modules of the second processing pipeline.

6. The apparatus of claim 1, wherein the one or more processing pipelines comprises a single processing pipeline and a first path of the plurality of different paths extends through a combination of the pipeline analytic modules and a second path of the plurality of different paths extends through a subset of the pipeline analytic modules of the combination.

7. The apparatus of claim 1, wherein each processing pipeline of the one or more processing pipelines comprises a separate unit of processing.

8. The apparatus of claim 7, wherein the pipeline data processor operates on different cores of the at least one hardware processor, and wherein the separate units of processing correspond to different individual cores of the different cores.

9. The apparatus of claim 7, wherein the at least one hardware processor comprises hardware processors distributed over different devices interconnected using external connectivity.

10. The apparatus of claim 1, wherein the wherein a source module of the at least one source module uses a map function to map incoming data of the at least one continuous data stream to different reducers selected from different ones of the pipeline analytic modules, and
wherein at least one of the reducers uses a map function to map its output to different reducers/sinks selected from the pipeline analytic modules or the at least one sink.

11. The apparatus of claim 1, further comprising a processing host implemented on the at least one hardware processor, the processing host to control runtime operations of the pipeline data processor to fully or partially regulate access to system resources by the pipeline data processor.

12. The apparatus of claim 11, wherein the at least one sink, the pipeline analytic modules, or the at least one source using one or more libraries to directly access the system resources.

13. The apparatus of claim 11, wherein the processor host uses portable APIs (Application Programming Interface) to fully or partially regulate the access.

14. The apparatus of claim 13, wherein the portable APIs comprise signal APIs for capturing CAN (Controller Area Network) bus signals or other system data or message bus APIs for sending and receiving data over an internal client network.

15. The apparatus of claim 13, wherein the portable APIs include runtime logging or profiling functionality.

16. An apparatus, comprising:
at least one hardware processor; and
a pipeline data processor implemented on the at least one hardware processor, the pipeline data processor including at least one source module providing at least one continuous data stream, a single forward-only pipeline comprising a sequence of pipeline analytic modules or plural forward-only pipelines comprising a plurality of sequences of pipeline analytic modules, and at least one sink module;
wherein a source module of the at least one source module uses a map function to map incoming data of the at least one continuous data stream to different reducers selected from different ones of the pipeline analytic modules, the different ones of the analytic modules selected from the sequence of pipeline analytic modules or the plurality of sequences of pipeline analytic modules, and
wherein at least one of the reducers uses a map function to map its output to different reducers/sinks selected from the sequence of pipeline analytic modules, the sequences of pipeline analytic modules, or the at least one sink.

17. The apparatus of claim 16, wherein the pipeline data processor operates on different cores of the at least one hardware processor.

18. The apparatus of claim 16, wherein the at least one hardware processor comprises hardware processors distributed over different devices interconnected using external connectivity.

19. The apparatus of claim 18, wherein different ones of the reducers are operated by different ones of the hardware processors.

20. The apparatus of claim 16, wherein the at least one data sources obtains data from a CAN (controller area network) bus, a file or queue, a network connection, or other resource of the at least one hardware processor.
